(19) United States
(12) Patent Application Publication
(10) Pub. No.: US 2024/0408718 A1
(43) Pub. Date: Dec. 12, 2024

(54) OPTICAL FIBER POLISHING HOLDER AND OPTICAL FIBER POLISHING MACHINE

(71) Applicant: SEIKOH GIKEN Co., Ltd., Matsudo-shi (JP)

(72) Inventors: Naoki KONUMA, Matsudo-shi (JP); Yuji SHIBUTANI, Matsudo-shi (JP)

(21) Appl. No.: 18/679,453

(22) Filed: May 31, 2024

(30) Foreign Application Priority Data
Jun. 7, 2023 (JP) 2023-093600

(51) Int. Cl. B24B 41/06; B24B 19/22

(52) U.S. Cl. CPC B24B 41/06; B24B 19/226

(57) ABSTRACT

Provided with an optical fiber ferrule polishing holder capable of making a polishing length of an optical fiber constant and adjusting the polishing length easily and an optical fiber ferrule polishing machine on which the holder can be installed. An optical fiber ferrule polishing holder used for polishing an optical fiber including: a holder body to which the optical fiber can be fixed; a movable member configured to be moved in a vertical direction with respect to a bottom surface of the holder body; and a position adjusting member configured to adjust a position of the movable member in the vertical direction.

### CROSS-REFERENCE TO RELATED APPLICATIONS

This patent specification is based on Japanese patent application, No. 2023-093600 filed on Jun. 7, 2023 in the Japan Patent Office, the entire contents of which are incorporated by reference herein.

### PRIOR ART

[Patent document 1] Japanese Patent Application Laid-Open No. 2003-19649

### BACKGROUND OF THE INVENTION

The present invention relates to an optical fiber ferrule polishing holder for holding an optical fiber when polishing the optical fiber and an optical fiber ferrule polishing machine for polishing the optical fiber held by the optical fiber ferrule polishing holder.

An optical fiber ferrule polishing machine is known where an optical fiber is installed on an optical fiber ferrule polishing holder, the optical fiber ferrule polishing holder is installed on the optical fiber ferrule polishing machine and the optical fiber is polished by rotating a polishing plate of the optical fiber ferrule polishing machine. In the above described machine, how long the optical fiber is polished (i.e., polish length, polishing margin or polishing amount of the optical fiber) is generally adjusted by changing the number of rotations of the polishing plate, the polishing time and the like.

On the other hand, Patent document 1 discloses a polishing machine where the optical fiber is installed on a tubular member arranged at a predetermined height position with respect to a polishing plate. In Patent document 1, the polishing length of the optical fiber becomes constant by making the height position of the optical fiber constant with respect to the polishing plate.

### SUMMARY OF THE INVENTION

In the method of adjusting the polishing length of the optical fiber by adjusting the number of rotations of the polishing plate and the polishing time, the polishing length may vary depending on a use state of a polishing film, an installation state of the optical fiber or the like. In the method shown in Patent document 1, although the polishing length of the optical fiber can be constant, it is not easy to adjust the polishing length because the height of the tubular member should be changed for changing the polishing length.

The present invention provides an optical fiber ferrule polishing holder capable of making a polishing length of an optical fiber constant and adjusting the polishing length easily and an optical fiber ferrule polishing machine on which the holder can be installed.

The optical fiber ferrule polishing holder of the present invention is an optical fiber ferrule polishing holder used for polishing an optical fiber, the optical fiber ferrule polishing holder including: a holder body to which the optical fiber can be fixed; a movable member configured to be moved in a vertical direction with respect to a bottom surface of the holder body; and a position adjusting member configured to adjust a position of the movable member in the vertical direction, wherein the position adjusting member is arranged above the movable member and the holder body, at least a part of the movable member is arranged between the holder body and the position adjusting member, and the position of the movable member in the vertical direction is adjusted so that the position adjusting member restricts an upward movement of the movable member at a predetermined position by adjusting a clearance between the position adjusting member and the movable member.

In the optical fiber ferrule polishing holder configured as described above, the polishing length of the optical fiber is adjusted by changing the position of the movable member in the vertical direction with respect to the bottom surface of the holder body.

In the above described configuration, it is also possible that the movable member includes a protrusion protruded downward from the bottom surface of the holder body, and the position adjusting member is configured to adjust a protrusion length of the protrusion protruded from the bottom surface of the holder body.

In the optical fiber ferrule polishing holder configured as described above, the polishing length of the optical fiber is adjusted by changing the protrusion length of the protrusion protruded downward from the bottom surface of the holder body to which the optical fiber is fixed.

In the above described configuration, it is also possible that the protrusion is arranged while passing through a through hole penetrating the holder body in the vertical direction.

In the optical fiber ferrule polishing holder configured as described above, the protrusion of the movable member penetrates through the through hole formed on the holder body and protrudes below from the bottom surface of the holder body.

In the above described configuration, it is also possible that the position adjusting member is arranged above the holder body.

In the optical fiber ferrule polishing holder as described above, the position of the movable member is adjusted by operating the position adjusting member at the position above the holder body.

In the above described configuration, it is also possible that the position adjusting member is configured to adjust the position of the movable member in the vertical direction by restricting an upward movement of the movable member at a predetermined position.

In the optical fiber ferrule polishing holder as described above, the polishing length of the optical fiber is adjusted by restricting the upward movement of the movable member at a predetermined position by the position adjusting member.

In the above described configuration, it is also possible that the position adjusting member is arranged above the movable member and the upward movement of the movable member is restricted at a predetermined position by adjusting a clearance between the position adjusting member and the movable member.

In the optical fiber ferrule polishing holder as described above, the position adjusting member is arranged above the movable member and the upward movement of the movable member is restricted at a predetermined position by adjusting the clearance between the position adjusting member and the movable member. Consequently, the polishing length of the optical fiber is adjusted.

In the above described configuration, it is also possible that the protrusion includes two or more protrusions formed on the movable member, the two or more protrusions are protruded from the bottom surface of the holder body at two or more positions, protrusion lengths of the two or more protrusions protruded from the bottom surface of the holder body are configured to be adjusted while being interlocked with each other by the position adjusting member.

In the optical fiber ferrule polishing holder configured as described above, two or more protrusions are protruded from the bottom surface of the holder body. Thus, the position of the movable member in the vertical direction is adjusted at two positions. In addition, the protrusion length of the two or more protrusions is adjusted while being interlocked with each other by the operation of the position adjusting member without being adjusted independently.

In the above described configuration, it is also possible that an energizing mechanism for energizing the movable member in a direction approaching the holder body is arranged between the movable member and the position adjusting member.

In the optical fiber ferrule polishing holder configured as described above, the energizing mechanism energizes the movable member in the direction approaching the holder body. Thus, the movable member is prevented from being moved suddenly when the force is added in the direction of separating the movable member from the holder body.

In the above described configuration, it is also possible that the position adjusting member includes a micrometer head.

In the optical fiber ferrule polishing holder configured as described above, the position of the movable member in the vertical direction is changed by the micrometer head easily and finely. Thus, the position of the movable member in the vertical direction is adjusted easily and finely.

In the above described configuration, it is also possible that an installation mechanism for installing an optical fiber fixing jig on the holder body is provided.

In the optical fiber ferrule polishing holder configured as described above, the optical fiber fixing jig is installed by the installation mechanism. Thus, the optical fiber can be easily attached/detached to/from the optical fiber ferrule polishing holder. In addition, it is not necessary to prepare the polishing holder independently for each object to be polished having different types of the optical fiber or the polishing shape. The polishing can be performed in accordance with each polishing specification by preparing the optical fiber fixing jig for each object to be polished and installing it to the installation mechanism of the holder body.

It is also possible to configure the present invention as an optical fiber ferrule polishing machine including the optical fiber ferrule polishing holder described above.

The present invention can provide an optical fiber ferrule polishing holder capable of making a polishing length of an optical fiber constant and adjusting the polishing length easily and an optical fiber ferrule polishing machine on which the holder can be installed.

### BRIEF DESCRIPTION OF DRAWINGS

FIG. 1 is a perspective view showing a state that an optical fiber ferrule polishing holder 20 is installed on an optical fiber ferrule polishing machine 10.

FIG. 2 is a cross-sectional view cutting the optical fiber ferrule polishing machine 10 on which the optical fiber ferrule polishing holder 20 is installed in a diagonal direction in a plan view.

FIG. 3 is a perspective view of the optical fiber ferrule polishing holder 20.

FIG. 4 is a plan view of the optical fiber ferrule polishing holder 20.

FIG. 5 is a cross-sectional view of the optical fiber ferrule polishing holder 20 cut along an A-A line of FIG. 4.

FIG. 6 is a cross-sectional view of the optical fiber ferrule polishing holder 20 cut along a B-B line of FIG. 4.

FIG. 7 is a partially cross-sectional view of the optical fiber ferrule polishing machine 10 and the optical fiber ferrule polishing holder 20 in a state that a movable member 22 is located at a lower position.

FIG. 8 is a partially cross-sectional view of the optical fiber ferrule polishing machine 10 and the optical fiber ferrule polishing holder 20 in a state that a movable member 22 is located at an upper position.

FIG. 9 is a partially cross-sectional view showing a state that the optical fiber ferrule polishing holder 20 is installed on an optical fiber ferrule polishing machine 110.

FIG. 10 is a partially cross-sectional view showing a state that an optical fiber ferrule polishing holder 220 is installed on an optical fiber ferrule polishing machine 210.

### DETAILED DESCRIPTION OF THE INVENTION

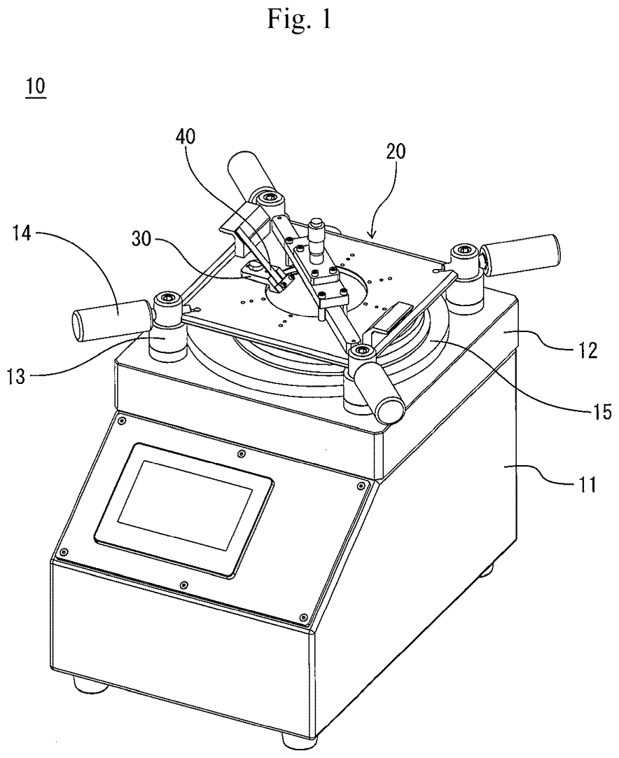

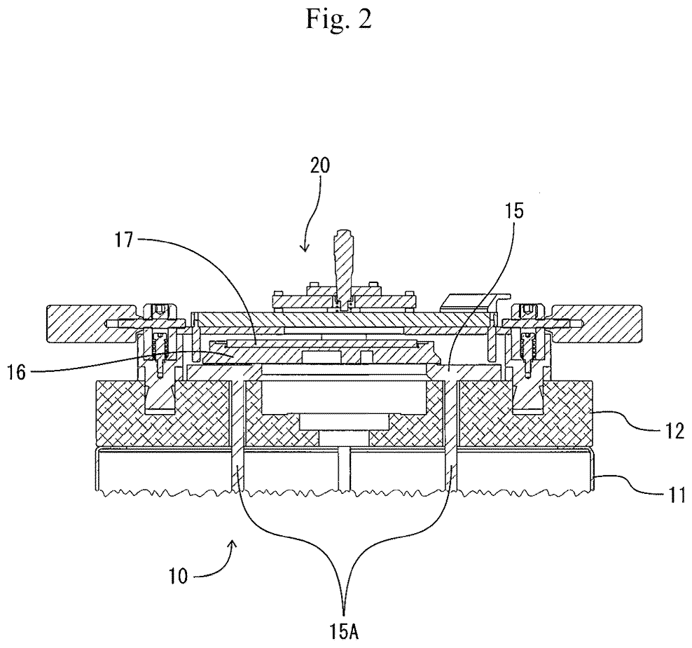

Hereafter, embodiments of the present invention will be explained with reference to the drawings shown as an example. FIG. 1 is a perspective view showing a state that an optical fiber ferrule polishing holder 20 (hereafter, a holder 20) is installed on an optical fiber ferrule polishing machine 10 (hereafter, a polishing machine 10). FIG. 2 is a cross-sectional view cutting the polishing machine 10 on which the holder 20 is installed in a diagonal direction in a plan view. FIG. 1 and FIG. 2 show a state that an optical fiber 40 is installed on the holder 20 via an optical fiber fixing jig 30 (hereafter, a jig 30). Although an example where one optical fiber 40 is installed on the holder 20 using one jig 30 is illustrated for simplifying the explanation, it is also possible to install a plurality of optical fibers 40 on the holder 20 using a plurality of jigs 30.

As shown in FIG. 1, the polishing machine 10 includes: a body portion 11 housing driving components and the like inside; and a base member 12 arranged above the body portion 11. The base member 12 is a plate-shaped member formed in an approximately rectangular shape in a plan view to have a predetermined thickness. Holding bases 13 for holding the holder 20 are provided respectively on four corners on an upper part of the base member 12. A clamp lever 14 is provided on each of the holding bases 13. The holder 20 can be fixed to the polishing machine 10 by placing the holder 20 on the holding bases 13 and rotating the clamp levers 14 in a horizontal direction. The position of the base member 12 in a height direction is constant with respect to the body portion 11. The position of the holding bases 13 in the height direction is constant with respect to the base member 12. When the holder 20 is fixed to the polishing machine 10, the holder 20 is fixed to a predetermined position in the height direction with respect to the base member 12 and the body portion 11 (i.e., a placing surface of the polishing machine 10). Note that the mechanism of fixing the holder 20 using the holding bases 13 and the clamp lever 14 is the conventional structure and therefore the detailed explanation is omitted.

The configurations of the polishing machine 10 will be explained with reference to FIG. 2. A movable support member 15 for supporting a polishing plate 17 and the like is arranged above the base member 12. The movable support member 15 is formed in a plate-shape having an approximately rectangular shape in a plan view and having a predetermined thickness. In addition, the movable support member 15 includes a shaft 15A penetrating through a through hole formed on the base member 12 and extending downward. The movable support member 15 is configured to be moved in a vertical direction (the height direction of the polishing machine 10) with respect to the body portion 11 and the base member 12 by applying a not-illustrated driving mechanism on the shaft 15A. A turntable 16 is placed on an upper surface of the movable support member 15. The polishing plate 17 is placed on an upper surface of the turntable 16. The turntable 16 is rotatably driven by a not-illustrated motor in a horizontal direction. The motor can include a rotation motor for rotating the turntable 16 and a revolution motor for revolving the turntable 16. When the turntable 16 is rotatably driven, the turntable 16 slides on an upper surface of the movable support member 15 while the turntable 16 is rotated/revolved. Namely, the polishing plate 17 is placed on the turntable 16 which can be slid on the movable support member 15. The turntable 16 is rotated in a state that the polishing plate 17 (i.e., a polishing pad and a polishing film) is placed on the upper surface of the turntable 16. Thus, the optical fiber 40 is polished by the polishing film or the like. In the present embodiment, the movable support member 15 and the turntable 16 correspond to a member for supporting the polishing plate 17. The conventionally known technologies can be used for the configuration and the operation for rotatably driving the turntable 16 and therefore the detailed explanation is omitted.

As described above, the movable support member 15 is configured to move in the height direction with respect to the base member 12. As the driving mechanism for moving the movable support member 15 in the height direction, a mechanical mechanism using a cam or the like and a fluid mechanism such as an air cylinder can be used, for example. The above described driving mechanism is conventionally known and therefore the detailed explanation is omitted. When the movable support member 15 is moved in the height direction, the turntable 16 and the polishing plate 17 move in the height direction while being interlocked (synchronized) with the movable support member 15. The position of the optical fiber 40 installed on the holder 20 in the height direction is fixed. Thus, when the polishing plate 17 is moved in the height direction, the relative position of the polishing plate 17 in the height direction varies with respect to the optical fiber 40. Namely, the polishing plate 17 approaches to the optical fiber 40 and separates from the optical fiber 40. When the polishing plate 17 is approached to the optical fiber 40 installed on the holder 20, a polishing pressure is applied to the optical fiber 40 to polish the optical fiber 40. The upward movement of the polishing plate 17 is restricted at a predetermined position. Thus, a relative distance between the optical fiber 40 and the polishing plate 17 can be fixed at a predetermined distance. Consequently, the polishing length of the optical fiber 40 is constant. The configuration of restricting the upward movement of the polishing plate 17 will be described later.

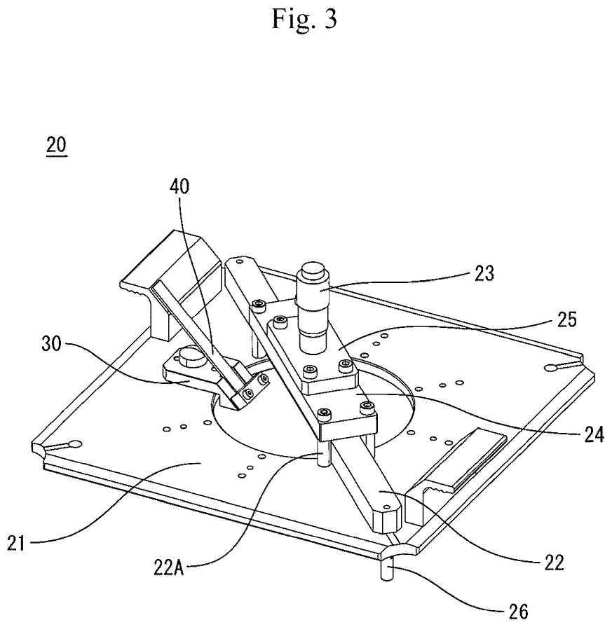

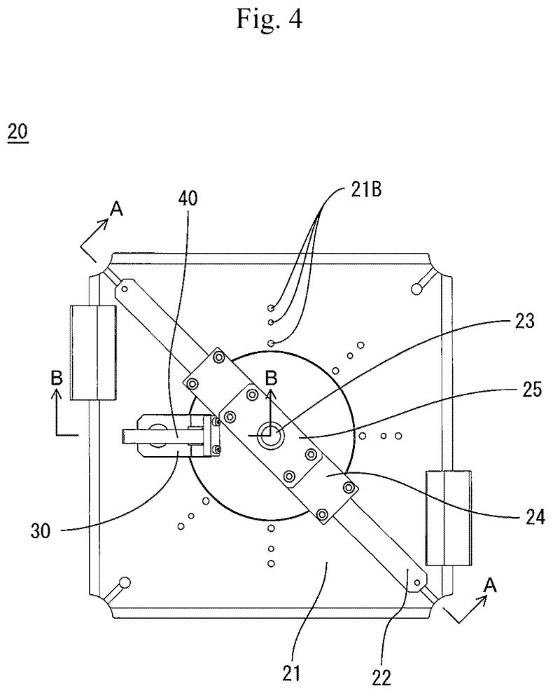

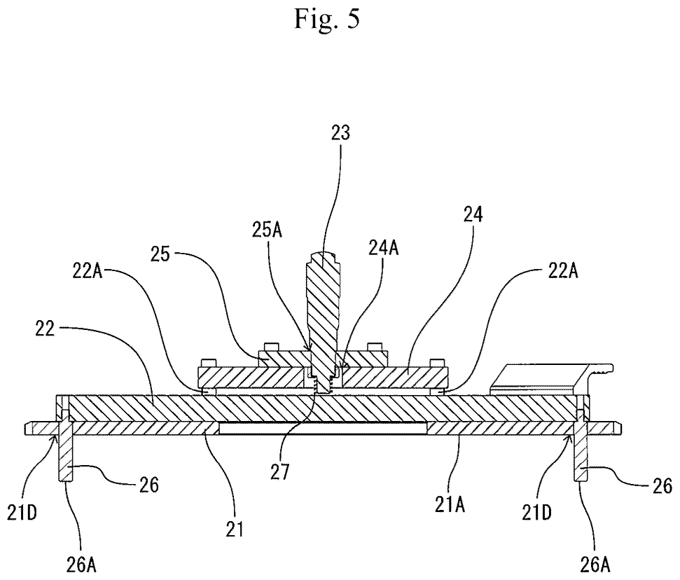

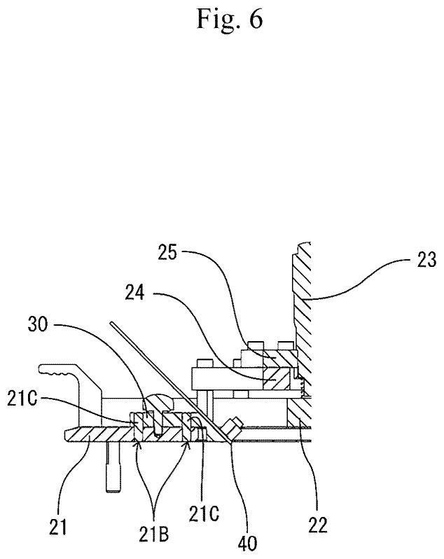

FIG. 3 is a perspective view and FIG. 4 is a plan view of the holder 20. FIG. 5 is a cross-sectional view of the holder 20 cut along an A-A line of FIG. 4. FIG. 6 is a cross-sectional view of the holder 20 cut along a B-B line of FIG. 4. The holder 20 is a member for holding the optical fiber 40 at a predetermined position with respect to the polishing surface of the polishing machine 10. The holder 20 includes: a holder body 21 to which the optical fiber 40 can be fixed; a movable member 22 configured to be moved in the vertical direction with respect to a bottom surface 21A of the holder body 21; a micrometer head 23 for restricting an upward movement of the movable member 22 at a predetermined position by changing the protrusion length of a tip portion of the micrometer head 23; and a first fixing member 24 and a second fixing member for fixing the micrometer head 23 at a predetermined height position with respect to the holder body 21. In the present embodiment, the micrometer head 23, the first fixing member 24 and the second fixing member 25 correspond to the position adjusting member configured to adjust a position of the movable member 22 in the vertical direction. Note that the adjustment of the position of the movable member 22 in the vertical direction here includes the adjustment of the upper end position of the movable member 22 in the vertical direction and the restriction of the movable member 22 in the vertical direction in the movable range. The upper end position is the highest position in the movable range of the movable member 22 and the farthest position from the polishing plate 17 of the polishing machine 10 in the vertical direction.

The holder body 21 is a member placed on the holding bases 13 of the polishing machine 10 and used in a state that the position of the holder body 21 is fixed with respect to the polishing machine 10. The holder body 21 is formed in a plate-shape having an approximately square shape in a plan view and a cylindrical hollow is formed on the center of the holder body 21. Installation holes 21B are formed on the holder body 21 for installing the jigs 30 for fixing the optical fibers on the jigs 30. Fixing pins 21C are fixed to the installation holes 21B and the jigs 30 are installed on the fixing pins 21C so that the optical fibers 40 can be installed on the jigs 30. In the present embodiment, the installation holes 21B and the fixing pins 21C correspond to the installation mechanism for installing the jig 30. When the optical fiber 40 is installed on the jig 30, the end portion of the optical fiber 40 is protruded downward from the bottom surface 21A of the holder body 21. In the above described state, the holder 20 is installed on the polishing machine 10 and the end surface of the optical fiber 40 is polished by the polishing machine 10. In the present embodiment, an angled polishing is performed in a state that the optical fiber 40 is arranged in a state of being inclined by a predetermined angle from the vertical direction without being arranged perpendicularly to the polishing surface of the optical fiber 40.

The movable member 22 is a plate-shaped member having a predetermined thickness and having a long rectangular shape in a plan view. The movable member 22 is arranged above the holder body 21 in a state that a longitudinal direction of the movable member 22 is directed along a diagonal line of the holder body 21 formed in the rectangular shape in a plan view. The holder body 21 is a member whose position in the height direction is fixed with respect to the polishing machine 10, while the movable member 22 is a member whose position in the height direction can be moved with respect to the holder body 21 and the polishing machine 10. Protrusions 26 extended downward are fixed to the bottom surface of both end portions of the movable member 22. The protrusions 26 have a circular cross-sectional shape in a plan view. The protrusions 26 are protruded from the bottom surface of the both end portions of the movable member 22 toward the polishing machine 10. The movable member 22 linearly connects the two protrusions 26 at a shortest distance. When the movable member 22 is arranged so as to contact the upper surface of the holder body 21, the protrusions 26 pass through the through holes 21D penetrating through the holder body 21 in the vertical direction and protruded downward from the bottom surface 21A of the holder body 21. The diameter of the protrusions 26 is slightly smaller than the diameter of the through holes 21D. The protrusions 26 are configured to be slid in the height direction in the through holes 21D. The movable member 22 is configured to move in the height direction between the upper surface of the holder body 21 and the bottom surface of the first fixing member 24. When the movable member 22 is moved in the height direction with respect to the holder body 21, the protrusion length (the protrusion length of the bottom surface 26A of the protrusions 26 with respect to the bottom surface 21A of the holder body 21) protruded from a bottom surface 26A of the protrusions 26 to the bottom surface 21A of the holder body 21 varies. An outer periphery portion (portion near outer periphery) of the movable support member 15 of the polishing machine 10 is positioned below the protrusions 26 fixed to the movable member 22. Thus, the protrusions 26 are configured to be in contact with the movable support member 15. Namely, when the movable support member 15 is moved upward, the movable support member 15 is configured to be in contact with the protrusions 26. When the movable support member 15 is further moved upward from the state that the movable support member 15 is in contact with the protrusions 26, the movable support member 15 can press (push) the protrusions 26 upward.

The first fixing member 24 is a plate-shaped member having greater width than that of the movable member 22 and shorter length than that of the movable member 22. The first fixing member 24 is fixed by bolts or the like to four pillars 22A protruded upward from the holder body 21. The second fixing member 25 is a plate-shaped member having an approximately same width as the first fixing member 24 and shorter length than the first fixing member 24. The second fixing member 25 is arranged on an upper surface of the first fixing member 24 and fixed by bolts or the like to the first fixing member 24. The micrometer head 23 is fixed to the second fixing member 25 in a state that the micrometer head 23 is inserted into an insertion hole 25A formed on a center portion of the second fixing member 25. A tip (lower end) of the micrometer head 23 penetrates through the insertion hole 25A, also penetrates through a through hole 24A formed on a center portion of the first fixing member 24, and protrudes downward from the bottom surface of the first fixing member 24. The first fixing member 24, the second fixing member 25 and a body portion (except for a movable portion located at the tip portion) of the micrometer head 23 are fixed to the holder body 21. Thus, the position of the body portion of the micrometer head 23 in the height direction is fixed with respect to the holder body 21.

The micrometer head 23 is configured so that the protrusion length of the tip portion protruded downward can be finely adjusted. When the protrusion length of the tip portion of the micrometer head 23 is adjusted, the protrusion length of the tip portion of the micrometer head 23 protruded downward from the bottom surface of the first fixing member 24 varies. Namely, the distance from the bottom surface of the holder body 21 to the tip portion of the micrometer head 23 varies. The tip portion of the micrometer head 23 is configured to abut on the movable member 22. Thus, the micrometer head 23 functions as the position adjusting member configured to adjust the position of the movable member 22. In the present embodiment, the tip portion of the micrometer head 23 acts (contacts) on the movable member 22 at an approximately center point between two protrusions in a plan view. Since the movable member 22 is configured to move between the upper surface of the holder body 21 and the bottom surface of the first fixing member 24 in the height direction, the protrusion length from the bottom surface 26A of the protrusions 26 to the bottom surface 21A of the holder body 21 here means the protrusion length when the movable member 22 is in contact with the bottom surface of the first fixing member 24. Namely, the protrusion length means the minimum protrusion length in the protrusion length from the bottom surface 26A of the protrusions 26 to the bottom surface 21A of the holder body 21. Accordingly, the position adjusting member here is the member for determining the upper limit potion in the movable range of the movable member 22. It can be also said that the position adjusting member is the member for determining the minimum protrusion length from the bottom surface 26A of the protrusions 26 to the bottom surface 21A of the holder body 21.

A spring 27 is arranged between the movable member 22 and the micrometer head 23 as the energizing mechanism. The upper end of the spring 27 is inserted into the lower part of the micrometer head 23, and the lower end of the spring 27 is in contact with the upper surface of the movable member 22. Consequently, the spring 27 acts between the upper surface of the movable member 22 and the tip portion of the micrometer head 23 to energize the movable member 22 downward. Namely, the spring 27 energizes the movable member 22 in a direction approaching the holder body 21. Consequently, when the movable support member 15 is moved upward and contacted with the protrusions 26 fixed to the movable member 22, the movable member 22 is prevented from being moved upward suddenly.

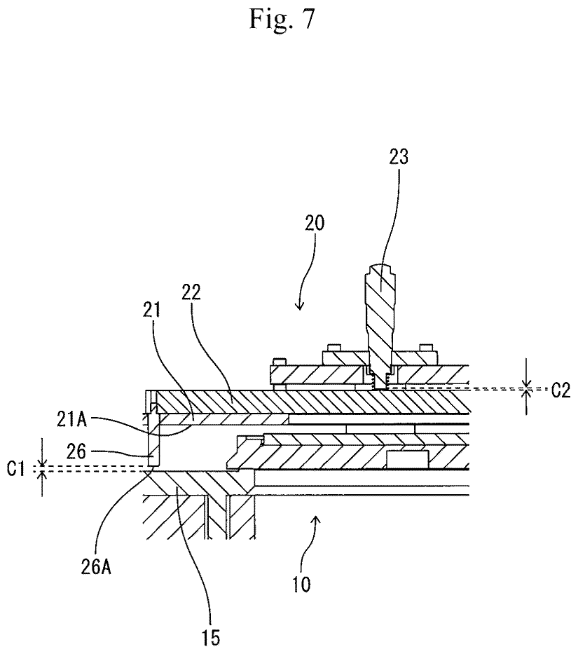

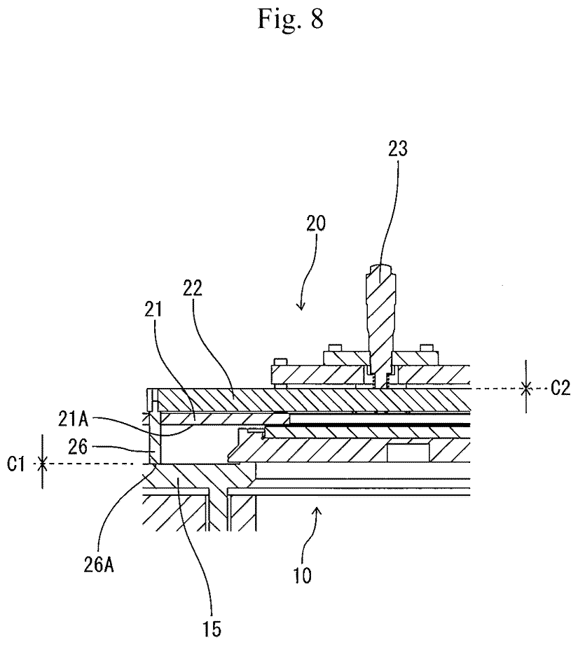

Hereafter, the operation when the movable member 22 is moved in the height direction will be explained. Note that the height direction is the vertical direction and the direction perpendicular to the bottom surface 21A of the holder body 21. FIG. 7 is a partially cross-sectional view of the polishing machine 10 and the holder 20 in a state that the movable member 22 is located at the lower position. FIG. 8 is a partially cross-sectional view of the polishing machine 10 and the holder 20 in a state that a movable member 22 is located at the upper position. FIG. 7 shows a state that the polishing has not yet started and shows a state that the movable support member 15 of the polishing machine 10 has not yet moved upward. In the above described state, the protrusions 26 fixed to the lower part of the movable member 22 is not in contact with the movable support member 15 of the polishing machine 10 and located at the lowermost position in the movable range of the movable member 22. At this time, a clearance C1 between the upper surface of the movable support member 15 and the bottom surface 26A of the protrusions 26 is maximum in the movable range. In addition, a clearance C2 between the upper surface of the movable member 22 and the end surface of the micrometer head 23 is maximum in the movable range.

When polishing the optical fiber 40, the movable support member 15 is moved upward from the state shown in FIG. 7. When the movable support member 15 is moved upward, the upper surface of the movable support member 15 abuts on the bottom surface 26A of the protrusions first. Namely, the clearance C1 between the upper surface of the movable support member 15 and the bottom surface 26A of the protrusions 26 gradually reduces and the clearance C1 disappears (C1=0). When the movable support member 15 is further moved upward from the above described state, the upper surface of the movable support member 15 presses the bottom surface 26A of the protrusions 26 upward. Accordingly, the movable member 22 is moved upward together with the protrusions 26, the clearance C2 between the upper surface of the movable member 22 and the end surface of the micrometer head 23 gradually reduces. As shown in FIG. 8, the movable support member 15 is moved upward until the upper surface of the movable member 22 abuts on the end surface of the micrometer head 23. When the upper surface of the movable member 22 abuts on the end surface of the micrometer head 23, the upward movement of the movable support member 15 and the movable member 22 is stopped. At this time, the clearance formed between the upper surface of the movable member 22 and the end surface of the micrometer head 23 disappears (C2=0). The protrusion length of the end portion of the micrometer head 23 protruded downward can be finely adjusted. Thus, the upward movement of the movable member 22 can be restricted at a predetermined position by adjusting the protrusion length of the end portion of the micrometer head 23. In other words, the upward movement of the movable member 22 can be restricted at a desired position by adjusting the clearance C2 between the upper surface of the movable member 22 and the end surface of the micrometer head 23 before the upward movement of the movable member 22 is not started. Namely, the movable range of the upward movement of the movable member 22 can be adjusted.

After the polishing of the optical fiber 40 is finished, the movable support member 15 is moved downward from the state shown in FIG. 8, the movable member 22 is moved downward together with the movable support member 15. Thus, the contact between the upper surface of the movable member 22 and the end surface of the micrometer head 23 is released. When the movable support member 15 is further moved downward, the contact between the upper surface of the movable support member 15 and the bottom surface 26A of the protrusions 26 is released at the timing when the movable support member 15 reaches a predetermined position. When the movable support member 15 is further moved downward, the downward movement of the movable support member 15 is stopped at the position shown in FIG. 7.

As explained above, in the present invention, the movable support member 15 of the polishing machine 10 is moved upward and downward. Thus, the movable support member 15 is made to abut on the protrusions 26 fixed to the movable member 22 of the holder 20 to move the movable member 22 upward and downward. The upward movement of the movable member 22 is restricted at a predetermined position by the micrometer head 23. Thus, the upward movement of the movable support member 15 can be stopped at the predetermined position. Consequently, when polishing the optical fiber 40, the distance in the height direction between the end portion of the optical fiber 40 protruded from the bottom surface 21A of the holder body 21 and the polishing plate 17 arranged above the movable support member 15 can be fixed at a constant position. Namely, the relative position in the vertical direction between the end portion of the optical fiber 40 and the movable member 22 can be fixed at a constant position. In addition, the position of the movable member 22 in the vertical direction can be easily adjusted by finely changing the protrusion length of the end surface of the micrometer head 23. The optical fiber 40 is installed on the holder body 21 whose position in the vertical direction is fixed, while the movable member 22 whose position in the vertical direction can be adjusted with respect to the holder body 21 is configured to be abutted on the polishing machine 10 when the polishing machine 10 and the holder 20 are approached to each other. Thus, the relative distance between the polishing surface of the polishing machine 10 and the bottom surface of the holder body 21 can be adjusted. By adopting the above described configurations, the polishing length of the optical fiber 40 can be fixed to a constant length and the polishing length of the optical fiber 40 can be easily changed. Even if the movable member 22 is slightly inclined with respect to the polishing surface of the polishing plate 17, the bottom surface 21A of the holder body 21 and the polishing surface of the polishing plate 17 are always kept in parallel. Accordingly, even when a plurality of optical fibers 40 are installed on the polishing holder 20, variation of the polishing length can be suppressed in the plurality of optical fibers 40. In addition, it is also possible to set the polishing length shorter at the beginning of the polishing and polish the optical fiber 40 while gradually changing the polishing length by adjusting the protrusion length of the end portion of the micrometer head 23 during the polishing.

The protrusions 26 are formed on both end portions of the movable member 22. Namely, the protrusions 26 are protruded from the bottom surface 21A of the holder body 21 at two positions. In addition, the micrometer head 23 is configured to abut on the movable member 22 at the intermediate portion of the two protrusions 26. Since the micrometer head 23 is configured to abut on the movable member 22 at the intermediate portion of the two protrusions 26, the protrusion lengths of the two protrusions 26 protruded from the bottom surface 21A of the holder body 21 are adjusted to the same length while being interlocked with each other. Since the movable member 22 and the movable support member 15 are in contact with each other at two points, the movable member 22 and the movable support member 15 can be kept in parallel.

Since the protrusions 26 are arranged to protrude downward in a state that the protrusions 26 pass through the through holes 21D penetrating through the holder body 21 in the vertical direction, it is not necessary to form the protrusions outside the holder body 21 and the protrusions 26 can be protruded toward the polishing machine 10 by a simple structure. Since the protrusions 26 are protruded below the holder body 21 and the position adjusting member such as the micrometer head 23 is arranged above the holder body 21, the position in the height direction can be adjusted above the holder body 21. Thus, the operability is excellent. Since the protrusions 26 are formed at two positions and the protrusions 26 and the movable support member 15 are in contact with each other at two positions, the distance between the bottom surface 21A of the holder body 21 and the polishing surface of the polishing plate 17 can be adjusted more correctly. Since the movable member 22 is energized by the spring 27 in a direction approaching the holder body 21, when the movable support member 15 presses the movable member 22 upward, the movable member 22 can be prevented from being moved upward suddenly. Consequently, the movable member 22 is prevented from colliding the end portion of the micrometer head 23 forcefully. Since the micrometer head 23 is used as the position adjusting member, the position of the movable member 22 in the vertical direction can be easily and finely adjusted.

In the above described embodiment, the example of directly installing the optical fiber on the holder is explained. However, the present invention is not limited to the above described configuration. For example, the present invention can be also applied to the configuration where the optical fiber installed on a ferule or an array is polished and the configuration where the optical fiber is installed on the holder via a connector or the like. In addition, in the above described embodiment, the example where an angled polishing is performed in a state that the optical fiber is inclined with respect to the polishing surface by a predetermined angle from the vertical direction is explained. However, the present invention is not limited to the above described configuration. The present invention can be also applied to the configuration where the optical fiber is arranged perpendicular to the polishing surface. Various types of optical fiber can be installed on the holder and polished by changing the structure of the jig for fixing the optical fiber.

In the above described embodiment, the example where the relative distance in the height direction between the polishing plate and the optical fiber is changed by moving the movable support member which supports the polishing plate of the polishing machine is explained. However, the polishing machine to which the present invention can be applied is not limited to the above described configuration. For example, the present invention can be also applied to the configuration where the relative distance in the height direction between the polishing plate and the optical fiber is changed by fixing the position of the polishing plate and moving the holder in the height direction. In that case, the downward movement of the holder is restricted at a predetermined position by the position adjusting member. The present invention can be applied as long as the holder and the polishing machine have the configuration where the relative distance in the height direction between the polishing plate and the holder can be changed.

In the above described embodiment, the example where the movable support member of the polishing machine abuts on the movable member of the holder and presses the movable member upward is explained. However, the portion of the holder to which the movable member abuts is not limited to the movable support member of the polishing machine. The movable member of the holder can abut on any portions of the polishing machine as long as the movable member of the holder abuts on the portion movable in the height direction. When the configuration where the holder is moved in the height direction and the polishing machine is not moved in the height direction is adopted, the movable member of the holder can abut on any portions of the polishing machine.

In the above described embodiment, the example where a long movable member is arranged on the upper surface of the holder body is explained. However, the shape of the movable member is not particularly limited. The shape of the movable member is not limited as long as the movable member is the member capable of moving relatively to the holder body in the height direction. In addition, the direction of arranging the movable member is not limited to the diagonal direction of the holder body. It is possible to use the movable member having a rectangular shape or a circular shape in a plan view. It is also possible to arrange the movable member in parallel with a line forming an outer shape of the holder body. It is also possible to form the movable member in an arc shape in a plan view so that the position adjusting member is acted on the center part of the movable member.

In the above described embodiment, the example where two protrusions protruded downward are formed on both end portions of the movable member is explained. However, the present invention is not limited to the above described configuration. For example, it is possible to form one protrusion or three or more protrusions. When two protrusions are formed, the movable member of the holder and the movable support member of the polishing machine can be kept further parallel. When two protrusions are formed and the position adjusting member is acted on the intermediate portion of the two protrusions, the positions of the two protrusions can be adjusted by one position adjusting member. In addition, since the position adjusting member is acted on the intermediate portion, the parallelism between the movable member of the holder and the movable support member of the polishing machine can be further improved. Note that the intermediate portion means the position approximately center of the two protrusions. The intermediate portion does not strictly mean the position equally distanced from the two protrusions.

In the above described embodiment, the example where the micrometer head is used as the position adjusting member is explained. However, the position adjusting member of the present invention is not limited to the above described configuration. For example, it is possible to adopt the configuration of adjusting the position of the movable member in the height direction by changing the number and the thickness of shims (spacers) to be sandwiched. In addition, the configuration where the upper limit position of the movable member in the height direction is restricted by the micrometer head is explained. However, the present invention is not necessarily limited to the above described configuration. In addition, the first fixing member and the second fixing member are used for fixing the micrometer head. However, it is not necessary to use two fixing members. It is not necessary to use the fixing member as long as the micrometer head can be fixed to the holder body. For example, it is possible that the end portion of the micrometer head is directly protruded downward from the lower surface of the holder and the micrometer head functions both as the movable member and the position adjusting member.

In the above described embodiment, the example where the spring is arranged between the movable member and the micrometer head as the energizing mechanism is explained. However, the place on which the energizing mechanism is arranged is not limited to the above described configuration. The place on which the energizing mechanism is arranged is not limited as long as the energizing mechanism energizes the movable member in a direction approaching the holder body. For example, it is possible to arrange the energizing mechanism between the bottom surface of the second fixing member and the movable member without inserting the energizing mechanism in the end portion of the micrometer head. In addition, the example where the spring is used as the energizing mechanism is explained. However, the energizing mechanism is not limited to the spring. For example, an elastic member such as a urethane, a hydraulic damper or the like can be used as the energizing mechanism.

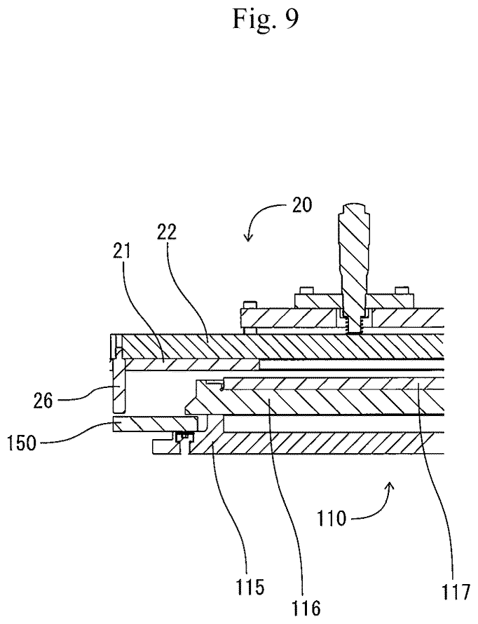

As another embodiment of the polishing machine, an optical fiber ferrule polishing machine 110 (hereafter, a polishing machine 110) will be explained. FIG. 9 is a partially cross-sectional view showing a state that the holder 20 is installed on the polishing machine 110. The holder 20 is the same as the holder used in the above described embodiment. The configurations of the polishing machine 110 are basically the same as those of the polishing machine 10 except for that an extension member 150 is fixed to a movable support member 115. The extension member 150 is a plate-shaped member fixed to the movable support member 115 which supports a turntable 116 and a polishing plate 117 and extended outward in the radial direction of the polishing plate 117. When the movable support member 115 is moved upward, the extension member 150 abuts on the protrusions 26 of the movable member 22 and presses the movable member 22 upward. Consequently, even when the position of the protrusions 26 of the movable member 22 is located outside of the movable support member 115, the extension member 150 can abut on the protrusions 26 and press the movable member 22 upward with respect to the holder body 21 in the height direction. Note that the member to which the extension member 150 is fixed is not limited to the movable support member 115. The extension member 150 can be fixed to any members as long as the extension member 150 is fixed to the member for supporting the polishing plate 117. For example, it is possible to fix the extension member 150 to the turntable 116.

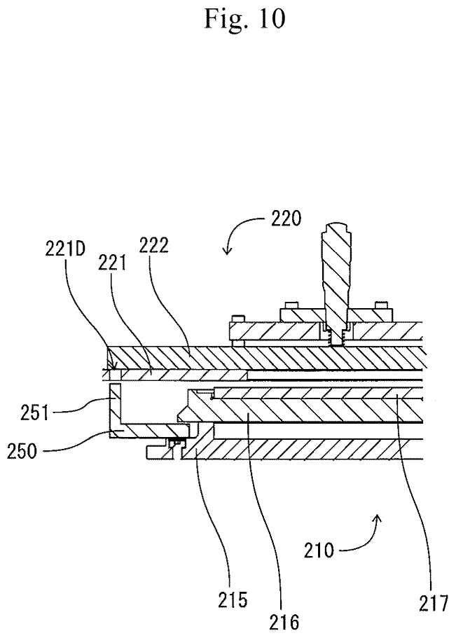

As another embodiment of the polishing machine and the holder, an optical fiber ferrule polishing machine 210 (hereafter, a polishing machine 210) and an optical fiber ferrule polishing holder 220 (hereafter, a holder 220) will be explained. FIG. 10 is a partially cross-sectional view showing a state that the holder 220 is installed on the polishing machine 210. The configurations of the polishing machine 210 are basically the same as those of the polishing machine 10 except for that an extension member 250 is fixed to a movable support member 215. The extension member 250 is a plate-shaped member fixed to the movable support member 215 which supports a turntable 216 and a polishing plate 217 and extended outward in the radial direction of the polishing plate 217. In addition, protrusions 251 having a circular shape in a plan view are protruded upward from the extension member 250 in the height direction. Namely, the extension member 250 and the protrusions 251 have an L-cross-sectional shape extended outward in the radial direction and protruded upward in a side view. The configurations of the holder 220 are basically the same as those of the holder 20 except for that the protrusions are not formed on the bottom surface of a movable member 222. Namely, in the present embodiment, instead of forming the protrusions on the bottom surface of the movable member 222, the protrusions 251 protruded upward are formed on the extension member 250 fixed to the movable support member 215. When the movable support member 215 is moved upward, the protrusions 251 of the extension member 250 pass through holes 221D of a holder body 221 and protruded above the holder body 221. Then, the protrusions 251 abut on the bottom surface of the movable member 222 and the movable member 222 is pressed upward with respect to the holder body 221. Consequently, the movable member 222 can be pressed upward in the height direction in a state that the bottom surface is formed flat without forming the protrusions on the bottom surface of the movable member 222. Note that the member to which the extension member 250 is fixed is not limited to the movable support member 215. The extension member 250 can be fixed to any members as long as the extension member 250 is fixed to the member for supporting the polishing plate 217. Note that it is also possible to form the protrusions on the movable member 222 and form the protrusions also on the extension member 250 so that the protrusions abut on the protrusions.

Note that, this invention is not limited to the above-mentioned embodiments. Although it is to those skilled in the art, the following are disclosed as the one embodiment of this invention.
Mutually substitutable members, configurations, etc. disclosed in the embodiment can be used with their combination altered appropriately.
Although not disclosed in the embodiment, members, configurations, etc. that belong to the known technology and can be substituted with the members, the configurations, etc. disclosed in the embodiment can be appropriately substituted or are used by altering their combination.
Although not disclosed in the embodiment, members, configurations, etc. that those skilled in the art can consider as substitutions of the members, the configurations, etc. disclosed in the embodiment are substituted with the above mentioned appropriately or are used by altering its combination.

### DESCRIPTION OF THE REFERENCE NUMERALS

10: optical fiber ferrule polishing machine, 11: body portion, 12: base member, 13: holding base, 14: clamp lever, 15: movable support member, 16: turntable, 17: polishing plate, 20: optical fiber ferrule polishing holder, 21: holder body, 22: movable member, 23: micrometer head, 24: first fixing member, 25: second fixing member, 26: protrusion, 27: spring, 30: optical fiber fixing jig, 40: optical fiber, 110: optical fiber ferrule polishing machine, 150: extension member, 210: optical fiber ferrule polishing machine, 220: optical fiber ferrule polishing holder, 250: extension member, 251: protrusion

1. An optical fiber ferrule polishing holder used for polishing an optical fiber, the optical fiber ferrule polishing holder comprising:
a holder body to which the optical fiber can be fixed;
a movable member configured to be moved in a vertical direction with respect to a bottom surface of the holder body; and
a position adjusting member configured to adjust a position of the movable member in the vertical direction, wherein
the position adjusting member is arranged above the movable member and the holder body,
at least a part of the movable member is arranged between the holder body and the position adjusting member, and
the position of the movable member in the vertical direction is adjusted so that the position adjusting member restricts an upward movement of the movable member at a predetermined position by adjusting a clearance between the position adjusting member and the movable member.

2. The optical fiber ferrule polishing holder according to claim 1, wherein
the movable member includes a protrusion protruded downward from the bottom surface of the holder body, and
the position adjusting member is configured to adjust a protrusion length of the protrusion protruded from the bottom surface of the holder body.

3. The optical fiber ferrule polishing holder according to claim 2, wherein
the protrusion is arranged while passing through a through hole penetrating the holder body in the vertical direction.

4. The optical fiber ferrule polishing holder according to claim 2, wherein
the protrusion includes two or more protrusions formed on the movable member,
the two or more protrusions are protruded from the bottom surface of the holder body at two or more positions,
protrusion lengths of the two or more protrusions protruded from the bottom surface of the holder body are configured to be adjusted while being interlocked with each other by the position adjusting member.

5. The optical fiber ferrule polishing holder according to claim 1, wherein
an energizing mechanism for energizing the movable member in a direction approaching the holder body is arranged between the movable member and the position adjusting member.

6. The optical fiber ferrule polishing holder according to claim 1, wherein
the position adjusting member includes a micrometer head.

7. The optical fiber ferrule polishing holder according to claim 1, further comprising:
an installation mechanism for installing an optical fiber fixing jig on the holder body.

8. An optical fiber ferrule polishing machine including the optical fiber ferrule polishing holder according to claim 1.

9. The optical fiber ferrule polishing machine according to claim 8, wherein
a protrusion protruded upward is provided on a member for supporting a polishing plate, and
the protrusion is configured to be in contact with the movable member.

10. The optical fiber ferrule polishing machine according to claim 8, wherein
a member for supporting a polishing plate includes an extension member which extends outward in a radial direction of the polishing plate, and
the movable member is configured to be in contact with the extension member.
